(19) United States
(12) Patent Application Publication
(10) Pub. No.: US 2026/0256047 A1
(43) Pub. Date: Sep. 3, 2026

(54) SYSTEM AND METHOD FOR VISUAL INDICATION OF AGRICULTURAL IMPLEMENT STATUS AND FIELD ILLUMINATION

(71) Applicant: CNH Industrial Canada, Ltd., Saskatoon (CA)

(72) Inventor: Trevor Lawrence Kowalchuk, Saskatoon (CA)

(21) Appl. No.: 19/067,370

(22) Filed: Feb. 28, 2025

(51) Int. Cl. A01C 7/10; A01B 79/00

(52) U.S. Cl. CPC A01C 7/102; A01B 79/005

(57) ABSTRACT

A control system for an agricultural seeding implement includes a controller having a memory and a processor. The controller is configured to receive at least one signal indicative of one or more operating parameters of each section of one or more sections of an agricultural system. The controller is further configured to compare the one or more operating parameters to one or more respective threshold reference operating parameters. The controller is also configured to control a lighting system to illuminate ground beneath the section of the one or more sections of the agricultural system based on the comparison of the one or more operating parameters to the one or more respective threshold reference operating parameters.

### BACKGROUND

The present disclosure relates generally to a system and method for visual indication of agricultural implement status and field illumination.

Generally, agricultural seeding implements (e.g., seeders) are towed behind a tractor or other work vehicle. Agricultural seeding implements typically include multiple row units distributed across a width of the agricultural seeding implement. Agricultural seeding implements utilize distribution lines to distribute agricultural product from central storage tank(s) to the row units. Due to the location of the air cart (e.g., behind the agricultural seeding implement) and the inclusion of multiple row units, monitoring operation of the agricultural seeding implement by visual inspection of the soil behind the agricultural seeding implement may be difficult.

### BRIEF DESCRIPTION

In certain embodiments, a control system for an agricultural seeding implement includes a controller having a memory and a processor. The controller is configured to receive at least one signal indicative of one or more operating parameters of each section of one or more sections of an agricultural system. The controller is further configured to compare the one or more operating parameters to one or more respective threshold reference operating parameters. The controller is also configured to control a lighting system to illuminate ground beneath the section of the one or more sections of the agricultural system based on the comparison of the one or more operating parameters to the one or more respective threshold reference operating parameters.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural system with a sensor system and a lighting system, in accordance with the present disclosure;

FIG. 2 is a perspective view of an embodiment of an agricultural seeding implement (e.g., seeder) that may be employed within the agricultural system of FIG. 1, in accordance with the present disclosure;

FIG. 3 is a block diagram of an embodiment of a status indication system that may be employed within the agricultural system of FIG. 1, in accordance with the present disclosure; and

FIG. 4 is a flow chart of an embodiment of a method of operation of a status indication system of an agricultural system, in accordance with the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

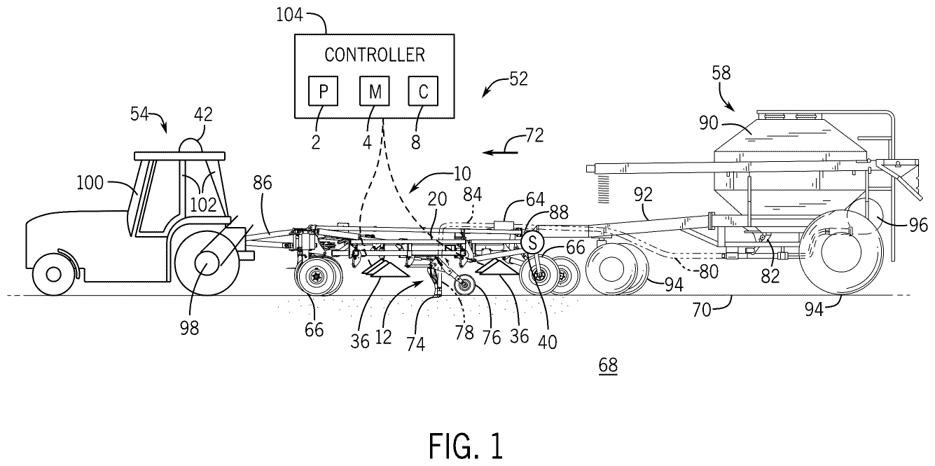

FIG. 1 is a side view of an embodiment of an agricultural system 52 with a sensor system and a lighting system. In the illustrated embodiment, the agricultural system 52 includes a work vehicle 54, an agricultural implement 10 (e.g., agricultural seeding implement), and an air cart 58. As depicted, the agricultural implement 10 includes a tool frame 20 coupled to a row unit 12, a header 64, and wheel assemblies 66. The agricultural implement 10 is towed by the work vehicle 54 (e.g., tractor) to deposit rows of agricultural product within soil 68. The wheel assemblies 66 contact a surface 70 of the soil 68 to enable the agricultural implement 10 to be towed by the work vehicle 54 along a direction of travel 72. As the agricultural implement 10 is towed along the direction of travel 72, a row of agricultural product may be deposited into the soil 68 by each row unit 12 (e.g., ground engaging opener assembly). Although only one row unit 12 is shown, the agricultural implement 10 may include multiple row units organized in one or more rows across the agricultural implement 10. In some embodiments, the agricultural implement may include one or more rows of 12, 14, 16, 18, 20, or more row units, which may each deposit a respective row of agricultural product into the soil.

To facilitate depositing the agricultural product into the soil 68, each row unit 12 includes an opener 74, a press wheel 76, and a product tube 78. While the opener 74 engages the soil 68, the opener 74 exerts a force onto the soil that excavates a trench into the soil as the row unit 12 travels through the field along the direction of travel 72. The agricultural product is deposited into the excavated trench via the product tube 78. Then, the press wheel 76 packs soil onto the deposited agricultural product. In certain embodiments, the press wheel of at least one row unit may be omitted. For example, at least one press wheel may be mounted to the frame of the agricultural implement 10 behind the at least one row unit. In certain embodiments, the row unit may also include a residue manager, a closing assembly, another suitable ground engaging tool, or a combination thereof. Furthermore, while the row unit includes a ground engaging opener assembly in the illustrated embodiment, in certain embodiments, at least one row unit on the agricultural implement may include an applicator assembly configured to deposit agricultural product onto the surface of the field or any other suitable type of material deposition assembly.

The header 64 is configured to provide the agricultural product to a group of row units 12. In some embodiments, the header 64 may pneumatically distribute the agricultural product from a primary line 80 to secondary lines 84. For example, a primary line 80 may direct agricultural product from the air cart 58 (e.g., a metering system 82 of the air cart 58) to the header 64. Additionally, the header 64 may distribute the agricultural product to the group of row units 12 via respective secondary lines 84. In certain embodiments, multiple primary lines may direct agricultural product to multiple headers. Moreover, multiple secondary lines may extend from each header to respective row units. Furthermore, in certain embodiments, at least one secondary line may extend to a secondary header, and multiple tertiary lines may extend from the secondary header to respective row units.

In the illustrated embodiment, the air cart 58 is towed behind the agricultural implement 10. For example, the agricultural implement 10 may be coupled to the work vehicle 54 by a first hitch assembly 86, and the air cart 58 may be coupled to the agricultural implement 10 by a second hitch assembly 88. However, in other embodiments, the agricultural implement 10 may be towed behind the air cart 58. In further embodiments, the implement and the air cart 58 may be part of a single unit that is towed behind the work vehicle or may be elements of a self-propelled vehicle.

The air cart 58 may centrally store agricultural product and distribute the agricultural product to the header 64. In the illustrated embodiment, the air cart 58 includes a storage tank 90, an air cart frame 92, wheels 94, and an air source 96. As illustrated, the towing hitch 88 is coupled between the tool frame 20 and the air cart frame 92, which enables the air cart 58 to be towed with the agricultural implement 10. Additionally, the storage tank 90 is configured to centrally store the agricultural product. In some embodiments, the storage tank 90 may include multiple compartments for storing different types of agricultural product. For example, a first compartment may store seeds while a second compartment may store a dry fertilizer. In such a configuration, the air cart 58 may deliver both seeds and fertilizer to the implement 56 via separate distribution systems (e.g., each distribution system including respective primary lines, respective headers, and respective secondary lines), or as a mixture through a single distribution system (e.g., including the primary lines, the headers, and the secondary lines).

From the storage tank 90, the agricultural product may be fed into the metering system 82, which meters the agricultural product into an airflow provided by the air source 96. The airflow fluidizes the agricultural product for distribution to the header 64 via the primary lines 80. As depicted, the metering system 82 is mounted to the bottom of the storage tank 90. To facilitate distributing the agricultural product, the airflow output by the air source 96 may be guided through the metering system 82 via a plenum. In some embodiments, the air source 96 may include one or more pumps and/or blowers powered by electric or hydraulic motor(s), for example.

In certain embodiments (e.g., embodiments in which the air cart 58 is towed behind the agricultural implement 10 or embodiments in which the air cart 58 is towed in front of the agricultural implement 10), the air source and/or the plenum may be mounted to a rear portion of the air cart 58 (e.g., relative to the direction of travel 72). In other embodiments (e.g., embodiments in which the air cart 58 is towed in front of the agricultural implement 10 or embodiments in which the air cart 58 is towed behind the agricultural implement 10), the air source and/or the plenum may be mounted to a front portion of the air cart 58 (e.g., relative to the direction of travel). Furthermore, in embodiments in which the air cart 58 includes multiple distribution systems, multiple air sources and/or plenums may be utilized. For example, if the air cart 58 includes two separate distribution systems for separately distributing seeds and fertilizer to the row units, the air cart 58 may include two air sources and two plenums (e.g., one air source and one plenum for each distribution system). In embodiments in which the air cart 58 includes a single distribution system (e.g., in which one or more products are metered into a single set of primary lines), a single air source and/or a single plenum may be utilized.

In the illustrated embodiment, a status indication system 200 is configured to monitor various parameters within the agricultural system 52. The status indication system includes a controller 104. The controller 104 is communicatively coupled to the sensor system 206 and to the lighting system 202. In the illustrated embodiment, the sensor system 206 is configured to monitor one or more parameters within the agricultural system 52 while the agricultural system 52 is moving in the direction of travel 72, thereby monitoring the parameters while the agricultural system 52 is in operation.

The controller 104 may include communication circuitry 8, one or more processors 2, and a memory 4. The communication circuitry 8 may facilitate wired or wireless communication between various components of the controller 104, as well as with external device(s), such as the lighting system 202, the sensor system 206, a mobile device, central or local controller(s) of the agricultural system, etc. The processor(s) 2 may include any suitable type of computer processor(s) and/or microprocessor(s) capable of executing computer-executable code. Moreover, the processor(s) 2 may include multiple microprocessors, one or more “general-purpose” microprocessors, one or more special-purpose microprocessors, and/or one or more application specific integrated circuits (ASICS), or some combination thereof. For example, the processor(s) 2 may include one or more reduced instruction set (RISC) or complex instruction set (CISC) processors. In some embodiments, the processor(s) 2 may receive inputs (e.g., signals) from sensor(s) of the sensor system 206 (e.g., via the communication circuitry 8). As such, the controller 104 may receive communication (e.g., the signal(s), sensor feedback data) associated with the agricultural system from the sensor(s) and control the lighting system 202. In some instances, the controller 104 may be positioned inside a cab of the work vehicle 54.

The memory 4 of the controller 104 may also be used to store the data, various other software applications, and the like that are executed by the processor(s) 2. The memory 4 may represent non-transitory computer-readable media (e.g., any suitable form of memory or storage) that may store the processor-executable code used by the processor(s) 2 to perform various techniques described herein. The component(s) of the controller 104 may be coupled to the work vehicle 54, the agricultural implement 10, the air cart 58, any other suitable component(s) of the agricultural system 52, or a combination thereof.

The sensor system 206 may monitor various parameters associated with operation of the agricultural system 52 and output signal(s) to the controller 104 indicative of data acquired by the sensor(s) (e.g., thermal sensor data, metered flow rate data, etc.). For example, in certain embodiments, the sensor system 206 includes one or more thermal (e.g., infrared, thermocouple, etc.) sensors configured to output signal(s) indicative of thermal emissions from monitored section(s) of the agricultural implement 10. The sensor system 206 may include any suitable sensors 40, such as thermal sensor(s), metered flow rate sensor(s), bulk flow rate sensor(s), pressure sensor(s), acoustic sensor(s), electrical field sensor(s), global positioning system (GPS) receiver(s), other suitable sensor(s), or a combination thereof.

The controller 104 is configured to receive the signal(s) from the sensor system 206 and to output signal(s) to control the lighting system 202. The controller 104 of the status indication system 200 may receive the signal(s) from the sensor system 206 and determine a current operating parameter (e.g., metered flow rate, bulk flow rate, temperature, etc.) based on the signal(s). For example, the status indication system controller 104 may determine a current metered flow rate of a respective row unit. The status indication system controller 104 of the status indication system 200 may receive the signal indicative of the metered flow rate from a metering system controller. The metering system controller may be the status indication controller 104. The controller 104 of the status indication system may compare the current operating parameter of a row unit (e.g., metered flow rate, bulk flow rate, temperature, etc.) to a threshold reference operating parameter (e.g., a threshold maximum operating parameter and/or a threshold minimum operating parameter). The controller 104 may then instruct the lighting system 202 to present a notification in response to determining that the current operating parameter is above a threshold maximum operating parameter (e.g., temperature, pressure, audio level, etc.) or below a threshold minimum operating parameter (e.g., pressure, bulk flow rate, metered flow rate, etc.). The notification from the lighting system may appear as a light-based indicator.

In some embodiments, the controller 104 may control the lighting system to flash light(s) located at the row unit(s) associated with the out-of-bounds operating parameter, while maintaining continuous light at the light(s) located at the row units with in-bound operating parameters. The flashing lights may alert the work vehicle operator that a certain current operating parameter of certain row unit(s) is above the threshold maximum operating parameter or below the threshold minimum operating parameter. In other embodiments, the controller 104 may control the lighting system to change the color of light emitted by the light(s) located at the row unit(s) associated with the out-of-bounds parameter. For example, the controller 104 may control the lighting system 202 to output white light from the light(s) located at row unit(s) with in-bound operating parameters, the controller 104 may control the lighting system 202 to output yellow light from the light(s) located at row units in which the metered flow rate is below the threshold minimum metered flow rate, and the controller 104 may control the lighting system 202 to output red light from the light(s) located at row unit(s) in which the bulk flow rate is below the threshold minimum bulk flow rate. As a result, the operator may receive a visual indicator that certain row unit(s) are not outputting agricultural product at the target flow rate (e.g., the bulk flow rate is below the threshold minimum bulk flow rate) and that certain row unit(s) are not outputting agricultural product due to automatic control (e.g., the metered flow rate is below the threshold minimum metered flow rate). In yet another embodiment, the controller 104 may control the lighting system 202 to change the color emitted by certain lights based on the particular out-of-bounds operating parameter. For example, the controller may control the lighting system to change the color emitted by certain lights to orange to indicate the air pressure at certain row units is below the threshold minimum operating pressure, to green to indicate the air pressure at certain row units is above the threshold maximum operating pressure, and to pink to indicate the temperature at certain row units is above the threshold maximum operating temperature.

In certain embodiments, the threshold reference metered flow rate may include a threshold target metered flow rate (e.g., in addition to a threshold minimum metered flow rate and/or a threshold maximum metered flow rate). In such embodiments, the controller may compare each metered flow rate to a respective threshold target metered flow rate. The controller may then control the lighting system to illuminate the ground beneath each section based on the respective comparison. For example, in response to determining that the metered flow rate for one section is above or below the threshold target metered flow rate (e.g., by more than a threshold value), the controller may instruct the lighting system to change the color of light output by one or more respective lights and/or to cause one or more respective lights to flash.

The sensor system may also be utilized to monitor other components within the agricultural system that emit heat, such as motors, hoses, lines, among others. For example, the controller may control the lighting system to notify the operator/technician that a temperature of a metering system motor is greater than a threshold maximum operating temperature, thereby enabling the operator/technician to take corrective action (e.g., check for clogs within the metering system, etc.). Furthermore, the controller may control the lighting system to notify the operator/technician that a temperature of electrical wiring is greater than a threshold maximum operating temperature and/or that a temperature profile of the electrical wiring differs from a reference temperature profile by more than a threshold amount (e.g., indicating a voltage drop, a magnetic field anomaly, etc.), thereby enabling the operator/technician to inspect and/or replace the wiring.

In certain embodiments, the sensor system may include an acoustic sensor, such as one or more microphones. The acoustic sensor may receive audio signals (e.g., sound waves) from various components of the agricultural system, such as the air source of the air cart 58, the row units 12, or the metering system 82 of the air cart 58, among other components of the agricultural system. The acoustic sensor, in turn, may output a signal indicative of acoustic sensor data to the controller 104 of the status indication system 200 (e.g., via respective transceivers). The status indication system controller 104 may compare the audio signals emitted by the acoustically monitored component to baseline/nominal audio signals for the acoustically monitored component. The status indication system controller 104 may also compare the audio signals emitted by the acoustically monitored component to audio signals associated with various fault conditions of the acoustically monitored component. The status indication system controller 104 may then control the lighting system 202 to present a visual indication of the performance of the acoustically monitored component. In some embodiments, the controller may control the lighting system to emit white light from the light(s) located at the row unit(s) in which the audio level is below a threshold maximum operating audio level, and the controller may control the lighting system to emit yellow light from the light(s) located at the row unit(s) in which the audio level is above the threshold maximum operating audio level. Further, in certain embodiments, the controller may control the lighting system to turn certain lights orange to indicate the audio level is above a higher threshold maximum operating audio level, or to indicate the audio level is a certain percentage above the threshold maximum operating audio level. The operator of the agricultural system and/or a technician may determine what is causing the acoustic anomaly in response to seeing the visual indication provided by the lighting system.

In certain embodiments, the sensor system includes an electric sensor, such as an electrical current sensor, an electrical voltage sensor, etc. The electric sensor may receive electric signals from various electrical components of the agricultural system, such as electrical wiring used in conjunction with the engine of the work vehicle 54, an electrical bus connecting the work vehicle 54 to the agricultural implement 10, electric motor(s) of the metering system 82, among other electrical components of the agricultural system 52. The electric sensor, in turn, may output a signal indicative of electric sensor data to the controller 104 of the status indication system (e.g., via respective transceivers). The status indication system controller 104 may compare the electric property/properties of the electrical component to baseline/nominal electric property/properties for the electrical component. The status indication system controller 104 may also compare the electric property/properties of the electrical component to electric property/properties associated with various fault conditions of the electrical component (e.g., indicative of a loose connection, voltage higher or lower than target voltage, etc.). In response to determining an electrical property is above or below a threshold electrical property, the controller 104 may control the lighting system 202 to present a visual indication of the performance of the electrical component. For example, in response to determining no electricity is flowing through an electric motor of the metering system (e.g., based on feedback from the electric sensor), the controller 104 may control the lighting system 202 to change the color of light emitted by the light(s) at the row unit(s) that receive agricultural product from the meter driven by the electric motor.

In some embodiments, the sensor system includes a pressure sensor. The controller 104 of the status indication system may receive a signal from the pressure sensor (e.g., via corresponding transceivers) and determine a current pressure within a secondary line to a row unit. The controller 104 of the status indication system may compare the current pressure to a threshold reference pressure. The controller 104 may then instruct the lighting system 202 to present a visual notification in response to determining the current pressure is above a threshold maximum pressure or below a threshold minimum pressure. The visual notification may appear as a light-based indication, as described above. For example, the controller 104 may control the lighting system 202 to change the color of the light emitted by light(s) at the row unit(s) coupled to the secondary line(s) in which the current pressure is above the threshold maximum pressure or below the threshold minimum pressure.

In certain embodiments, the sensor system includes a bulk flow rate sensor. The controller 104 of the status indication system may receive a signal from the bulk flow rate sensor (e.g., via corresponding transceivers) and determine a current bulk flow rate to a row unit. The controller 104 of the status indication system may compare the current bulk flow rate to a threshold reference bulk flow rate. The controller 104 may then instruct the lighting system 202 to present a visual notification in response to determining the current bulk flow rate is above a threshold maximum bulk flow rate or below a threshold minimum bulk flow rate. The visual notification may appear as a light-based indication, as described above. For example, the controller 104 may control the lighting system 202 to change the color of the light emitted by light(s) at the row unit(s) in which the current bulk flow rate is above the threshold maximum bulk flow rate or below the threshold minimum bulk flow rate.

In certain embodiments, the sensor system includes global positioning system (GPS) receiver(s). The controller 104 of the status indication system may receive signal(s) from the GPS receiver(s) (e.g., via corresponding transceivers) and determine a location and/or an orientation of the agricultural implement within the field. The controller 104 of the status indication system may compare the current location of each section of the agricultural implement to previously seeded location(s). The controller 104 may then instruct the lighting system 202 to present a visual notification in response to determining the current seeding location of at least one section matches previously seeded location(s). The visual notification may appear as a light-based indication, as described above. For example, the controller 104 may control the lighting system 202 to change the color of the light emitted by respective light(s).

In certain embodiments, the bulk flow rate sensor(s) include flow blockage sensor(s). The controller 104 of the status indication system may receive signal(s) from the flow blockage sensor(s) (e.g., via corresponding transceivers) and determine a current bulk flow rate to each monitored section (e.g., each monitored row unit) based on feedback from the flow blockage sensor(s). The controller 104 of the status indication system may compare the bulk flow rate at each section (e.g., each row unit) to a respective threshold minimum bulk flow rate. The controller 104 may then instruct the lighting system 202 to present a visual notification in response to determining the bulk flow rate of at least one section is below the respective threshold minimum bulk flow rate (e.g., which may indicate flow blockage(s)). The visual notification may appear as a light-based indication, as described above. For example, the controller 104 may control the lighting system 202 to change the color of the light emitted by respective light(s) (e.g., at the row unit(s) associated with the blockage(s)).

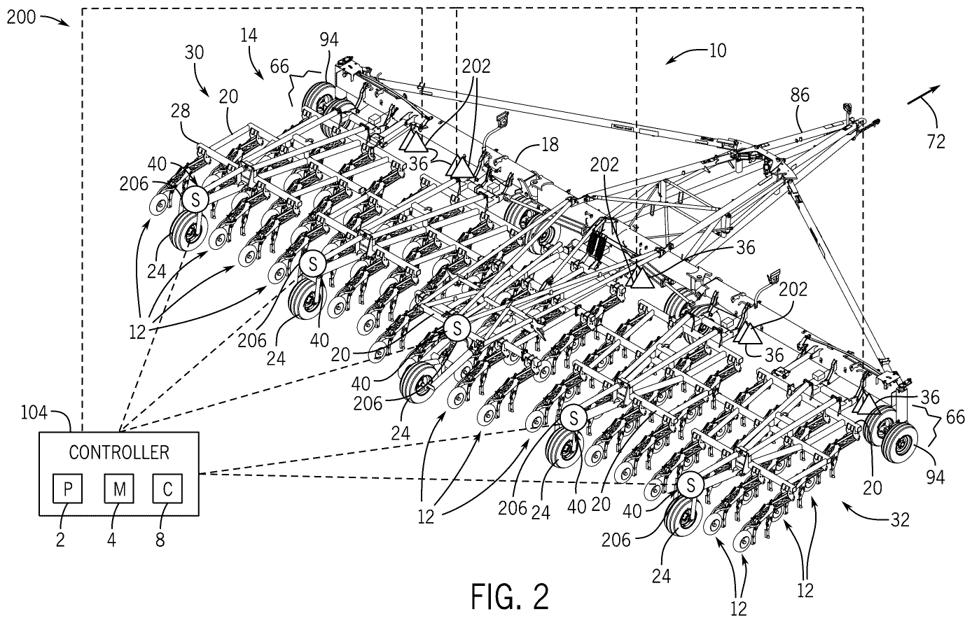

FIG. 2 is a perspective view of an embodiment of an agricultural implement 10 (e.g., seeder) that may be employed within the agricultural system of FIG. 1. In the illustrated embodiment, the agricultural implement 10 includes a frame 14 having a hitch assembly 86, a main support bar 18, and tool frames 20. The hitch assembly 86 is configured to couple to a hitch of the work vehicle (e.g., tractor) to enable the work vehicle to move the agricultural implement 10 along a direction of travel 72. The hitch assembly 86 is coupled to the main support bar 18, and the main support bar 18 is coupled to the tool frames 20. As illustrated, each tool frame 20 is supported by a wheel 24 of a respective wheel assembly 66, and the main support bar 18 is supported by wheels 94 of multiple wheel assemblies 66. In certain embodiments, each tool frame is pivotally coupled to the main support bar to enable the tool frame to follow contours of the soil surface. However, in other embodiments, each tool frame is rigidly (e.g., non-rotatably) coupled to the main support bar (e.g., such that the tool frames and the main support bar form a unitary structure). Furthermore, while the frame 14 includes five tool frames 20 in the illustrated embodiment, in other embodiments, the frame may include more or fewer tool frames (e.g., 1, 2, 3, 4, 6, 7, 8, 9, 10, or more).

In the illustrated embodiment, each row unit 12 is coupled to a toolbar 28 of a respective tool frame 20 and configured to deposit agricultural product within the soil. In certain embodiments, the row units 12 are laterally offset (e.g., offset in a direction perpendicular to the direction of travel 72) from one another, such that adjacent rows of agricultural product are established within the soil. While the agricultural implement frame 14 includes the main support bar 18 and the tool frames 20 in the illustrated embodiment, in other embodiments, the frame may include other and/or additional elements to support the row units 12. For example, in certain embodiments, the main support bar may be omitted, a center tool frame may be coupled to the hitch assembly, and wing tool frames may be coupled to the center tool frame. Furthermore, in certain embodiments, the tool frames may be omitted, and the row units 12 may be directly coupled to the main support bar (e.g., toolbar), thereby forming a single row of row units 12.

In the illustrated embodiment, each row unit 12 of the agricultural implement 10 includes an opener that forms a trench for agricultural product deposition into the soil. An agricultural product tube, which may be positioned adjacent to the opener, is configured to deposit agricultural product into the trench. The opener and the agricultural product tube are followed by a packer wheel that packs soil on top of the deposited agricultural product. In certain embodiments, each row unit includes a depth control system configured to control a position of the packer wheel relative to the opener to control the penetration depth of the opener within the soil.

The status indication system 200 of the agricultural implement 10 also includes the controller 104 as described above in FIG. 1. The agricultural implement 10 may include one or more sections. Each section may include one or more row units 12. The number of row units 12 in each section may be based on the type of agricultural product being dispensed by each row unit 12, the desired flow rate of each row unit 12, other suitable parameter(s), or a combination thereof. As such, each section may include one or more agricultural product tubes, one or more lights 36, and one or more sensors 40. In certain embodiments, each section of the agricultural implement corresponds to a respective primary line and header. Accordingly, each row unit of the section may receive agricultural product from a common primary line and a common header. Further, the sections may have the same number or a different number of row units 12. For example, the agricultural implement may have 13 row units and 7 sections, in which 6 of the sections have 2 row units, and 1 section has 1 row unit. As another example, the agricultural implement may have 6 row units and 3 sections, in which one section has 3 row units, another section has 2 row units, and a further section has 1 row unit.

The lights 36 of the lighting system 202 may provide field illumination in low-light conditions. Further, the controller 104 may control the lights 36 of the lighting system 202 to provide visual indications to the operator. The lights 36 of the lighting system 202 may indicate operating state(s) and/or operating conditions(s) with one or more row units 12. The controller 104 may control the lights 36 of the lighting system 202 based on feedback from the sensors 40 of the sensor system 206. For each section of the row unit, the controller 104 may control the lights 36 of the respective section to indicate a change in operating state and/or an operating condition in response to determining operating parameter(s) of the section are above respective threshold maximum operating parameter(s) or below respective threshold minimum operating parameter(s). One or more lights 36 may be located on each section of the agricultural implement, thereby enabling the operator to identify the section associated with the change in operating state and/or operating condition. As used herein, an “operating parameter of a section” refers to an operating parameter that relates to (e.g., affects) one or more row units of the section.

In the illustrated embodiment, the lights 36 are coupled to the main support bar 18 and directed rearwardly to illuminate the ground beneath the row units of the respective sections. However, the lights may be located at any other suitable positions within the agricultural implement (e.g., alone or in combination with the lights coupled to the main support bar, as illustrated). For example, in certain embodiments, a light may be coupled to each row unit, or lights may be coupled to certain row units. Further, the lights 36 may include a strip of lights connected to the frame at each section along a substantial portion of the section. The lights 36 may point directly at the field. The lights 36 may be bright enough, wide enough in scope, or both, to cover a substantial portion (e.g., an entirety) of the field beneath the agricultural implement when fully illuminated. In some embodiments, the operator may be able to adjust the direction of the lights 36 either manually and/or remotely.

The sensors 40, which are included in the sensor system 206, may include a metered flow rate sensor, a bulk flow rate sensor, a pressure sensor, a temperature sensor, an audio sensor, an electric sensor, or the like. Feedback from the sensors 40 may enable the controller to determine the metered flow rate of agricultural product (e.g., from one or more meters), the bulk flow rate of the agricultural product (e.g., to one or more sections, to one or more row units), the pressure (e.g., at one or more points in the lines), the temperature (e.g., at certain row units), the audio levels emitted from one or more locations on the agricultural implement, the flow of electricity to power one or more elements of the agricultural implement, or a combination thereof. Each sensor 40 may be mounted at any suitable location on the agricultural implement based on the respective monitoring parameter of the sensor (e.g., sound, flow rate, etc.). For example, a pressure sensor may be coupled to a primary line or to a secondary line. As another example, an electric sensor may be mounted near the element operating on electricity, such as a pump.

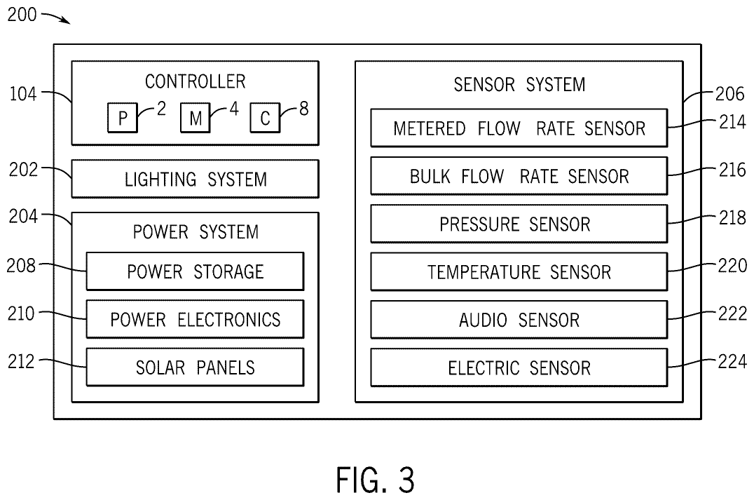

FIG. 3 is a block diagram of an embodiment of the status indication system 200 that may be employed within the agricultural system of FIG. 1. The status indication system 200 includes the controller 104, the lighting system 202, a power system 204, and the sensor system 206. As previously discussed, the controller 104 includes communication circuitry 8, one or more processors 2, and a memory 4. The controller 104 is described above with reference to FIG. 1.

The lighting system 202 may include one or more lights (e.g., at each row unit). The lights may emit light (e.g., continuously) during operation of the agricultural system to illuminate the field below the agricultural implement 10. In certain embodiments, multiple lights of the lighting system 202 may be positioned at each row unit (e.g., to indicate different current operating parameters vary from respective threshold reference operating parameters, such as pressure, metered flow rate, etc.).

In some embodiments, the lighting system 202 may include multiple lights of different colors (e.g., at each row unit). For example, the lighting system 202 may include white lights, yellow lights, orange lights, and red lights to distinguish between different levels of an operating parameter and/or different operating parameters (e.g., bulk flow rate, electrical property/properties, temperature, etc.). In certain embodiments, the lighting system 202 may include one light of one color at each row unit, and the controller may be configured to control the lighting system 202 to cause the light to flash to alert the operator to a current operating parameter of a row unit varying from a threshold reference operating parameter (e.g., being above the threshold maximum operating parameter or below the threshold minimum operating parameter). The lights may flash faster to indicate a greater variation, and slower to indicate a smaller variation. The lights may also flash at one speed regardless of the variation. In certain embodiments, the lighting system 202 may include one or more lights that change color (e.g., red, green, blue light emitting diode (LED)), and the controller may be configured to control the lighting system 202 to cause the light to change between (e.g., flash) different colors. The lights may illuminate in a first color in response to the controller determining operating parameters are between respective threshold minimum operating parameters and respective threshold maximum operating parameters, and the lights may change to a second color in response to the controller determining at least one operating parameter is above the respective threshold maximum operating parameter or below the respective minimum threshold operating parameter. For example, the light may illuminate the field in white as a base illumination color, but may illuminate the field in red in response to at least one operating parameter being above the respective threshold maximum operating parameter or below the respective threshold minimum operating parameter. In some embodiments, the light may illuminate a third color to indicate a different operating state and/or operating condition.

In some embodiments, the lighting system 202 may also include the headlights of the work vehicle. The headlights of the work vehicle may provide a visual indication to alert the operator to view the agricultural implement. The headlights may operate in conjunction with the lights at the row units. The headlights may alert the operator via a change in illumination. For example, the headlights may flash to indicate to the operator that at least one current operating parameter is above the threshold maximum operating parameter or below the threshold minimum operating parameter for at least one of the row units. The operator may then turn around and view the lights at the row units 12 to determine which row unit(s) are affected. In some embodiments, the color or flash of the headlights may also indicate the severity or the particular operating parameter having the variation.

In certain embodiments, the status indication system 200 also includes the power system 204. The power system may include power storage 208, power electronics 210, solar panels 212, or a combination thereof. The power system 204 may provide electrical power to the lighting system 202 from the solar panels 212, the power storage 208 (e.g., batteries), the work vehicle 54, or a combination thereof. The power storage 208 may store energy from the solar panels 212, from the work vehicle 54, or a combination thereof.

The status indication system 200 also includes the sensor system 206. The sensor system 206 may include metered flow rate sensors 214, bulk flow rate sensors 216, pressure sensors 218, temperature sensors 220, audio sensors 222, electric sensors 224, or a combination thereof. The sensors disclosed with reference to FIG. 3 correspond to the sensors 40 disclosed with reference to FIGS. 1-2. The sensors may be on certain row unit(s) (e.g., each row unit), at certain primary line(s) and/or certain secondary line(s) (e.g., each secondary line), at certain electrical component(s) (e.g., motor(s), connector(s), line(s), etc.), or a combination thereof. The bulk flow rate sensors 216 may be mounted on the secondary lines. The bulk flow rate sensors 216 may monitor the flow rate of agricultural product (e.g., seed) flowing from the air cart to the row units. In addition, the metered flow rate sensors 214 may be mounted at the meters of the metering system (e.g., at the motors driving the meters). For example, a bulk flow rate that is sporadic or below the threshold bulk flow rate may indicate a clogged primary or secondary line or that the respective storage compartment is empty or nearly empty. A metered flow rate or a bulk flow rate that is above the threshold maximum metered/bulk flow rate may reduce yield. If the bulk flow rate and/or metered flow rate is below the threshold lower bulk/metered flow rate or above the threshold maximum bulk/metered flow rate, the controller 104 may control the lighting system 202 to provide a visual indication of the variation on the applicable row unit(s), as described with reference to FIG. 1.

The pressure sensors 218 may be mounted anywhere along the primary lines and/or the secondary lines, and/or at any other suitable locations (e.g., at the row units). A low pressure at a row unit may indicate a clog within the primary line or the secondary line that feeds the row unit. Conversely, a high pressure may be indicative of excessive output from the air source. In response to the controller 104 determining that the pressure is below the threshold minimum pressure or above the threshold maximum pressure, the controller 104 may control the lighting system 202 to provide a visual indication of the variation at the applicable row unit(s), as described with reference to FIG. 1.

The temperature sensors 220 may be mounted at any suitable location(s) on the row units 12 and/or at any suitable location(s) on other component(s) of the agricultural system. For example, the temperature sensors 220 may be mounted on electrical wires, primary lines and/or secondary lines, motors, etc. The temperature sensors 220 may detect a temperature of the respective component, which may be indicative of a clogged line, rotational resistance, etc. In response to the controller 104 determining that the temperature is below the threshold minimum temperature or above the threshold maximum temperature, the controller 104 may control the lighting system 202 to provide a visual indication of the variation at the applicable row unit(s), as described with reference to FIG. 1.

The audio sensors 222 may include any suitable devices configured to detect acoustic sound (e.g., microphones). The audio sensors 222 may be mounted at any suitable location(s) on the row units and/or at any suitable location(s) on other component(s) that may makes sound when in operation. Due to the noisy operating environment of the agricultural system, the audio sensors 222 may be located close to the potential sound source. Further, the audio sensors 222 may be sensitive to frequencies expected to be emitted by the component(s) being monitored. In response to the controller 104 determining that the sound level is below the threshold minimum sound level or above the threshold maximum sound level, the controller 104 may control the lighting system 202 to provide a visual indication of the variation at the applicable row unit(s), as described with reference to FIG. 1.

The electric sensors 224 may be mounted along electrical lines (e.g., in the row units and/or other suitable components) and/or at electrical components of the agricultural system. Each electric sensor may monitor electric signals from electrical component(s) of the agricultural system, such as electrical wiring used in conjunction with the engine of the work vehicle, an electrical bus connecting the work vehicle to the agricultural implement, electric motor(s) of the metering system, among other electrical components of the agricultural system. In response to the controller 104 determining that an electrical property is below the threshold minimum electrical property or above the threshold maximum electrical property, the controller 104 may control the lighting system 202 to provide a visual indication of the variation at the applicable row unit(s), as described with reference to FIG. 1.

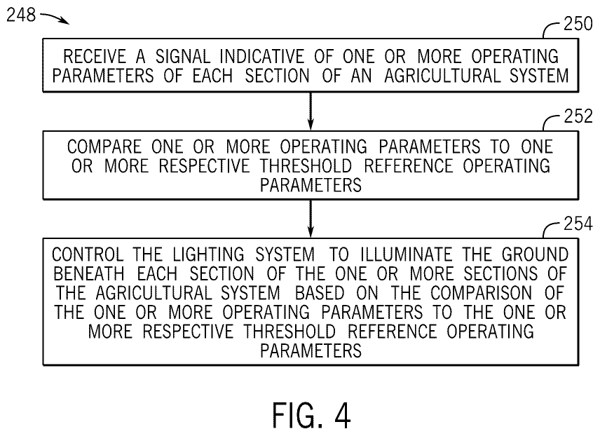

FIG. 4 is a flow chart of an embodiment of a method 248 of operation of a status indication system of an agricultural system. The method 248 may be performed by the controller disclosed above with reference to FIGS. 1-3, by one or more other suitable controllers, or a combination thereof. Furthermore, the steps of the method 248 may be performed in the order disclosed below or in any other suitable order. In addition, in certain embodiments, one or more steps of the method 248 may be omitted, and/or the method may include one or more additional steps.

At block 250, a signal indicative of one or more operating parameters of each section of an agricultural system is received. As discussed above, the signal may be received from the sensor system. For example, the signal may be output by a metered flow rate sensor, a bulk flow rate sensor, a pressure sensor, a temperature sensor, an audio sensor, or an electric sensor.

At block 252, the one or more operating parameters are compared to one or more respective threshold reference operating parameters. As discussed above, multiple thresholds (e.g., maximum and minimum) may be used for certain operating parameters (e.g., temperature, sound level, bulk flow rate, etc.). In certain embodiments, a single threshold (e.g., maximum or minimum) may be used for certain operating parameters (e.g., pressure, metered flow rate, etc.). In some embodiments, at least one of the threshold reference operating parameters may be adjusted by the user. In certain embodiments, at least one of the threshold reference operating parameters may be preset with a recommended value.

At block 254, the lighting system is controlled to illuminate the ground beneath each section of the one or more sections of the agricultural system based on the comparison of the one or more operating parameters to the one or more respective threshold reference operating parameters. As discussed above, the lighting system may be controlled to illuminate the ground differently depending on the comparison of the operating parameter(s) to the respective threshold reference operating parameter(s). However, the ground may be illuminated by the lighting system while the agricultural system is in operation regardless of the comparison. As a result, the operator may view the field while the agricultural system is in operation during low light conditions (e.g., at night). In some embodiments, the lights at the row units may be activated and remain a single color (e.g., white, yellow, etc.) while the operating parameter(s) are within the bounds of the respective threshold reference operating parameter(s). If one or more operating parameters is above the respective threshold maximum operating parameter(s) or below the respective threshold minimum operating parameter(s), the lighting system may be controlled to change the color(s) of respective light(s) to indicate the variation. In some embodiments, the color may be selected based on the severity of the variation (e.g., orange for a smaller variation, red for a larger variation, etc.). In some embodiments, the color may be selected based on the particular operating parameter having the variation (e.g., red for temperature, purple for metered flow rate, etc.). If variations are present for multiple operating parameters, the lighting system may be control to switch the lights between the colors corresponding to the respective operating parameters, or one color may be selected corresponding to one of the operating parameters. The one operating parameter may be selected based on priority, based on the magnitude of the variation, or based on a combination thereof. In certain embodiments, the lighting system may be controlled to flash light(s) to indicate an operating parameter variation. The rate of the flash may increase based on the magnitude of the variation. The flash may also have a different cadence or pattern based on the particular operating parameter having the variation.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A status indication system for an agricultural system, comprising:
a controller comprising a memory and a processor, wherein the controller is configured to:
receive at least one signal indicative of one or more operating parameters of each section of one or more sections of an agricultural system;
compare the one or more operating parameters to one or more respective threshold reference operating parameters; and
control a lighting system to illuminate ground beneath the section of the one or more sections of the agricultural system based on the comparison of the one or more operating parameters to the one or more respective threshold reference operating parameters.

2. The control system of claim 1, wherein the agricultural system comprises an agricultural seeding implement.

3. The control system of claim 1, wherein each section of the one or more sections of the agricultural system comprises one or more row units.

4. The control system of claim 1, wherein the controller is configured to control the lighting system to control a color of light output by one or more lights of the lighting system.

5. The control system of claim 4, wherein the controller is configured to control the color of the light output by the one or more lights based on a difference between the one or more operating parameters and the one or more respective threshold reference operating parameters.

6. The control system of claim 1, wherein the one or more operating parameters comprise metered flow rate, bulk flow rate, pressure, temperature, or a combination thereof.

7. The control system of claim 1, wherein the controller is configured to control the lighting system to cause one or more lights of the lighting system to flash.

8. An agricultural system, comprising:
a plurality of sensors, wherein each sensor of the plurality of sensors is configure to output a respective signal indicative of a respective operating parameter of a respective section of one or more sections of the agricultural system;
a lighting system comprising a plurality of lights, wherein each light of the plurality of lights is configured to illuminate ground beneath a respective section of the one or more sections of the agricultural system; and
a controller having a memory and a processor, wherein the controller is communicatively coupled to the plurality of sensors and to the lighting system, and the controller is configured to:
receive, for each section of the one or more sections, each respective signal indicative of the respective operating parameter of the section;
compare, for each section of the one or more sections, each respective operating parameter to a respective threshold reference operating parameter; and
control, for each section of the one or more sections, the lighting system to illuminate the ground beneath the section based on the comparison of each operating parameter to the respective threshold reference operating parameter.

9. The agricultural system of claim 8, wherein the controller is configured to control the lighting system to control a color of light output by a respective light of the plurality of lights.

10. The agricultural system of claim 9, wherein the controller is configured to control the color of the light output by the respective light based on a difference between the operating parameter and the respective threshold reference operating parameter.

11. The agricultural system of claim 8, wherein the plurality of sensors comprises a metered flow rate sensor, a bulk flow rate sensor, a pressure sensor, a temperature sensor, or a combination thereof.

12. The agricultural system of claim 8, wherein the controller is configured to control the lighting system to cause a respective light of the plurality of lights to flash.

13. The system of claim 8, wherein the plurality of lights is configured to couple to a main support bar of the agricultural system.

14. The agricultural system of claim 8, wherein the one or more operating parameters comprise metered flow rate, bulk flow rate, pressure, temperature, or a combination thereof.

15. The agricultural system of claim 8, wherein at least one light of the plurality of lights comprises a red, green, blue light emitting diode (LED).

16. A method for monitoring operation of an agricultural system, comprising:
receiving, via a controller comprising a processor and a memory, at least one signal indicative of one or more operating parameters of each section of one or more sections of an agricultural system;
comparing, via the controller, the one or more operating parameters to one or more respective threshold reference operating parameters; and
controlling, via the controller, a lighting system to illuminate ground beneath the section of the one or more sections of the agricultural system based on the comparison of the one or more operating parameters to the one or more respective threshold reference operating parameters.

17. The method of claim 16, wherein controlling the lighting system comprises controlling a color of light output by one or more lights of the lighting system.

18. The method of claim 17, wherein controlling the color of the light output by the one or more lights comprises controlling the color of the light output by the one or more lights based on a difference between the one or more operating parameters and the one or more respective threshold reference operating parameters.

19. The method of claim 16, wherein controlling the lighting system comprises controlling one or more lights of the lighting system to flash.

20. The method of claim 16, wherein the one or more operating parameters comprise metered flow rate, bulk flow rate, pressure, temperature, audio level, an electrical property, or a combination thereof.
